(19) United States
(12) Patent Application Publication
(10) Pub. No.: US 2026/0167067 A1
(43) Pub. Date: Jun. 18, 2026

(54) VEHICLE SEAT

(71) Applicant: Faurecia Autositze GmbH, Hannover (DE)

(72) Inventors: Erwan GUILLOUET, Hespe (DE); Martin MACHATE, Lindhorst (DE); Andre PICKER, Hespe (DE)

(73) Assignee: Faurecia Autositze GmbH, Hannover (DE)

(21) Appl. No.: 19/422,351

(22) Filed: Dec. 16, 2025

(30) Foreign Application Priority Data
Dec. 18, 2024 (DE) 10 2024 138 568.5

(51) Int. Cl. B60N 2/20

(52) U.S. Cl. CPC B60N 2/20

(57) ABSTRACT

The invention relates to a vehicle seat having a seating portion and a backrest portion being pivoting connected with one another via a seat recliner mechanism, the vehicle seat comprising an angle measurement system including a sensor assembly by means of which the tilt adjustment of the backrest portion in relation to the seating portion can be determined.

The invention provides that the angle measurement system is provided with a shifting mechanism on the seating portion and one on the backrest portion, where the shifting mechanism on the seating portion is provided with a shifting element which is supported movable along a first shifting direction, and the shifting mechanism on the backrest portion is provided with a shifting element which is supported movable along a second shifting direction, where the shifting elements are swiveling coupled together in a pivot point so that in the event of a tilt adjustment of the backrest portion an angle (α) between the two shifting elements changes, and the sensor assembly is configured to put out a sensor signal depending on the angle (α).

This application claims priority to German Patent Application No. 10 2024 138 568.5, filed Dec. 18, 2024, which is hereby incorporated herein by reference in its entirety.

The invention relates to a vehicle seat according to the preamble of claim 1.

Vehicle seats with a seating portion and a backrest portion usually have a tilt adjustment means allowing for a pivot motion of the backrest portion into multiple seat positions. Hereby, the pivot motion is controlled by a seat recliner mechanism, also referred to as “recliner,” comprising a fitting member on the backrest and a fitting member on the seating portion which can be turned against each other via a, eccentrically acting adjustment mechanism. A seat recliner mechanism of such a type has been described, for example, in the documents U.S. Pat. No. 8,146,995 B2 , EP 2 420 403 B1 or WO 202417138A1 .

Seat recliner mechanisms of this type create a sort of tumbling motion, i.e., both a rotational motion as well as a translational motion of the two fitting members in relation to one another or, respectively, of the backrest portion in relation to the seating portion. Therefore, it is a complex feat to obtain information on the pure rotational position in relation to the seating portion or a reference, for example, an angle of rotation, by measuring the rotational position of the two fitting members in relation to one another, because the translational component also has an influence on of the measuring result of a corresponding rotation sensor between the two fitting members. The document U.S. Pat. No. 10,358,053 B2 provides for determining the rotational position of the backrest portion via a rotation sensor measuring the rotational position of an adjusting motor that drives the adjustment mechanism of the seat recliner mechanism.

The invention is based on the object of providing a vehicle seat allowing for a simple and reliable measuring of the rotational position of the backrest portion.

This task is solved by a vehicle seat according to the independent claim. Preferred further developments are described in the sub-claims.

Thus, according to the invention, a vehicle seat having a seating portion and a backrest portion is provided, where the seating portion is connected to the backrest portion via a seat recliner mechanism, preferably a tumble fitting, so that the backrest portion can be pivoted about a swivel axis in relation to the seating portion. Preferably, a so-called tumble fitting is utilized as the seat recliner mechanism, wherein, usually, a rotational motion about the swivel axis occurs in combination with a translational motion of the swivel axis, because an eccentrically acting adjustment mechanism is provided between a fitting member on the seating portion and a fitting member on the backrest portion.

The vehicle seat further comprises an angle measurement system including a sensor assembly, the sensor assembly being configured to generate and put out a sensor signal characterizing the tilt adjustment of the backrest portion in relation to the seating portion. Hereby, it is provided that the angle measurement system includes a shifting mechanism on the seating portion, which is affixed to the seating portion, and a shifting mechanism on the backrest portion, which is affixed to the backrest portion, where the shifting mechanism on the seating portion has a shifting element on the seating portion which is mounted on the seating portion movable along a first shifting direction, and the shifting mechanism on the backrest portion has a shifting element on the backrest portion which is mounted on the backrest portion movable along a second shifting direction different from the first shifting direction.

It is further provided that the shifting element on the seating portion and the shifting element on the backrest portion are swiveling coupled with one another in a pivot point, for example, via a mounting element, so that an angle between the two shifting elements and thereby also the position of at least one of the shifting directions or the position of the shifting directions in relation to each other changes when the tilt of the backrest portion in relation to the seating portion is adjusted. Moreover, the sensor assembly is configured to put out the sensor signal depending on the angle between the two shifting elements.

Advantageously, such an angle measurement system allows for detecting only the rotational motion of the shifting elements in relation to one another and, thereby, from a geometric viewpoint, solely the rotational motion of the backrest portion about the swivel axis. Thus, for example, the utilization of a tumble fitting also results in translational components in the pivot motion of the backrest portion then these shall be filtered out by the fact that the shifting elements allow for longitudinal displacement on the seating portion or on the backrest portion respectively, and solely the rotational component of the movement is detected and transferred into the rotation about the pivot point. By virtue of a suitable calibration or, respectively, from knowing the mounting position, then follows the tilt adjustment of the backrest from a geometric viewpoint so that the rotation position of the backrest portion can be reliably determined in a simple manner. This follows from the fact that the two shifting elements upon adjustment of the backrest portion in relation to the seating portion are subjected to the same change of the angle included between them as the backrest portion in relation to the seating portion. Thus, by means of a suitable initialization or calibration respectively, in which the mounting position of the shifting elements is taken into account, it is possible to deduce the rotational position of the backrest portion in a simple manner.

Advantageously, it is further provided that the shifting mechanism on the seating portion has a guide element firmly attached to the seating portion in which the shifting element on the seating portion is mounted so that it is longitudinally displaceable mounted, and the shifting mechanism on the backrest portion has a guide element firmly attached to the backrest portion, in which the shifting element on the backrest portion shifting element is longitudinally displaceable mounted. Hereby, the terms ‘firmly attached to the seating portion’ or ‘firmly attached to the backrest portion’ respectively are to be understood meaning that the respective guide element is in a fixed position, i.e., is able to move only in a fixed manner together with the seating portion or with the backrest portion respectively. The terms ‘on the seating portion’ or ‘on the backrest portion’, however, are to be understood meaning that the respective shifting element, while indeed being assigned to the seating portion or the backrest portion respectively, is still able to move in relation thereto. In this context, the term ‘longitudinally displaceable’ means that the shifting element can move along its longitudinal extension. i.e., in this case, in the respective shifting direction in relation to the respective position fixed guide element.

Thus, this way a suitable guide of the respective shifting element is provided so that the movement in the respective guide direction is determined. Hereby, according to a possible embodiment, it is provided that the first shifting direction of the shifting element on the seating portion lies on or at least parallel to a longitudinal axis of the seating portion, and/or

the second shifting direction of the shifting element on the backrest portion lies on or at least parallel to a longitudinal axis of the backrest portion.

This way, advantageously, the mounting position is determined so that the angle of the backrest portion in relation to the seating portion can be unambiguously deduced from the angle between the two shifting elements from geometric viewpoints, in particular, following a prior initialization, thereby simplifying the effort of determining the tile adjustment of the backrest portion. Moreover, this leads to a simple assembly and an optimized utilization of space because the elongated shifting elements are guided along the longer longitudinal axes.

According to another embodiment, however, the position fixed guide elements may also be arranged on the seating portion or backrest portion respectively such that the respective shifting direction of the shifting elements mounted longitudinally displaceable therein lies at an angle to the longitudinal axis of the seating portion or of the backrest portion respectively. In this embodiment, too, the angle of the backrest portion in relation to the seating portion can be unambiguously deduced from geometric viewpoints, in particular, following a prior initialization.

In a particularly preferred variant, the position fixed guide elements are arranged on the seating portion or backrest portion respectively such that in-between the two shifting elements for any possible adjustments of the backrest portion in relation to the seating portion, i.e., within a range of adjustments possible or, respectively, admissible during normal operation, there will always be an angle of unequal 0° possible or, respectively, of unequal 180° (i.e., the shifting elements do not run parallel to one another).

Preferably, it is further provided that the shifting element on the seating portion and/or the shifting element on the backrest portion is mounted movable in the respective shifting direction by means of a slide bearings or a rolling bearings with balls or rollers. This guarantees a simple and reliable shiftability of the shifting elements so as to securely compensate for the translational motion.

Preferably, it is further provided that the sensor assembly is provided with an electronic rotation sensor and/or tilt sensor that is adapted to determine, on the basis of an optical and/or a mechanical and/or a magnetic operating principle, a value for the angle between the shifting elements and to put out the sensor signal depending thereon. This allows a continuous detection of the angle and, therewith, the tilt adjustment of the backrest portion in a simple manner.

However, in addition or in the alternative, it may be provided that the sensor assembly is provided with a control cam which is attached to one of the shifting elements (of the one shifting mechanism), and a switching element having at least two switching positions which is attached to the respective other shifting element (of the other shifting mechanism), so that the control cam adjusts in relation to the switching element when the backrest portion pivots in relation to the seating portion, whereby the control cam acts on the switching element at least in individual angle regions of the angle between the two shifting elements so as to adjust or change a switching position of the switching element, and the sensor assembly is adapted to generate the sensor signal depending on the switching position of the switching element.

This required no additional costly sensor system with a downstream electronic evaluation. Rather, the design of the control cam can be adapted to the respective vehicle seat so that the adjustment of the shifting elements in relation to one another and, therewith, the tilt adjustment of the backrest portion can be detected simply and securely directly via the switching element, i.e., by virtue of it being actuated, without additional effort of evaluation.

Preferably, it is further provided that the control cam is provided with a control surface, preferably facing radially outwards and/or in an axial direction (in relation to the pivot point), where the control surface acts on the switching element depending on the angle between the two shifting elements so as to set the switching element in the respective switching position or to maintain the switching position or to change the switching position. Thus, the control surface can be flexibly adapted to the respective desired application.

Preferably, it is further provided that allocated to each switching position of the switching element is at least one angle or at least one angular range between the two shifting elements, and to each angle or each angular range between the two shifting elements at least one tilt adjustment of the backrest portion in relation to the seating portion. This way, the respective rotational position can be deduced directly from the switching signal of the switching element, thereby simplifying the determination of the tilt adjustment of the backrest portion.

Hereby, for example, it may be provided that the switching element has two switching position, and the control cam is configured, for example, by virtue of a suitable implementation of the control surface, such that it
in a first angular range of the angle, does not act on the switching element or acts on the switching element in such a way that the switching element is set in a first switching position, whereby the backrest portion in the first angular range of the angle is preferably in an upright seating position, and
in a second angular range of the angle, acts on the switching element in such a way that the switching element is set in a second switching position, whereby the backrest portion in the second angular range of the angle is preferably between the upright seating position and an easy entry position, and
in a third angular range of the angle, does not act on the switching element or acts on the switching element in such a way that the switching element is set in the first switching position, whereby the backrest portion in the third angular range of the angle is in the easy entry position.

This make it possible, in the event of the second switching position, to detect by means of the sensor signal whether the seating portion is between the upright seating position and the easy entry position, for example, because the backrest portion is correspondingly released. However, in the event of the first switching position, it can be assumed that the backrest portion is in the easy entry position or the upright seating position. Thus, by means of the sensor, the positioning can be recognized signal for suitable further use. For further differentiation, depending on the application, further switching positions and, correspondingly, further angular ranges may be provided in which the control cam collaborates with the switching element in an application specific manner.

The invention is further illustrated in the following by way of one embodiment by means of the accompanying drawings. It is shown in:

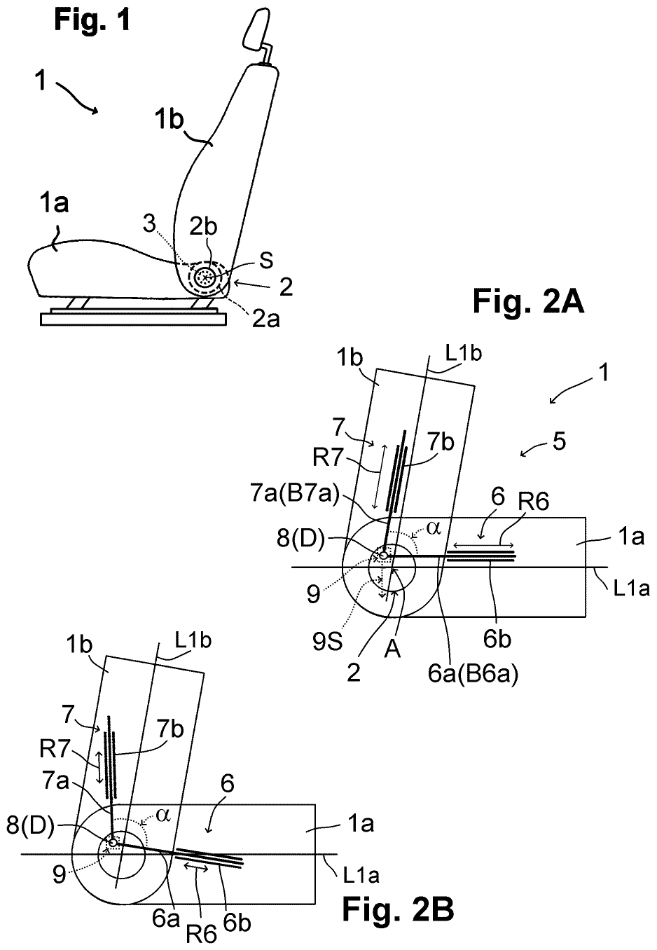

FIG. 1 a vehicle seat in a schematic side view;

FIGS. 2A, 2B detail views of an angle measuring system on the vehicle seat according to FIG. 1 in different arrangements with a first embodiment of a sensor assembly;

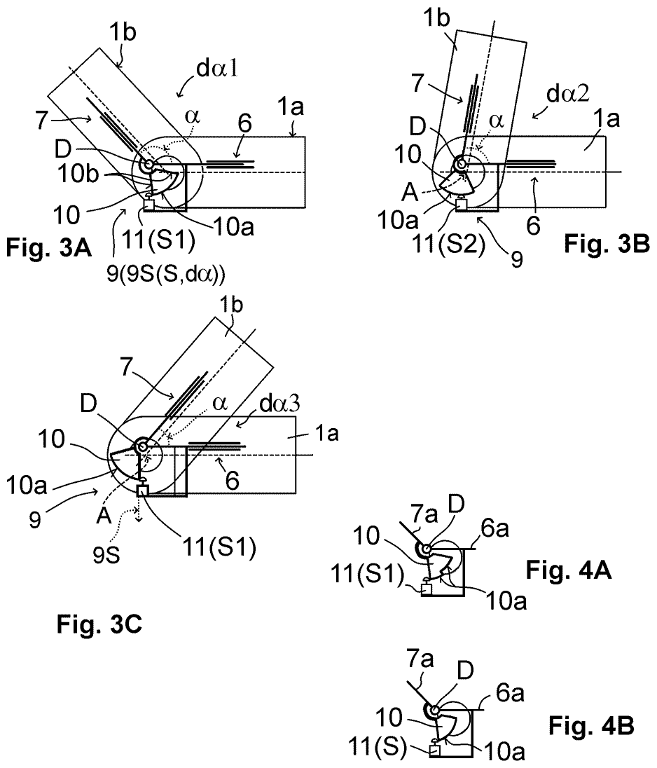

FIGS. 3A, 3B, 3C different pivot positions of a backrest portion of the vehicle seats according to FIG. 1 with a second embodiment of a sensor assembly; and

FIG. 4a, 4b further variants of the second embodiment of the sensor assembly.

FIG. 1 shows schematically a vehicle seat 1 with a seating portion 1a and a backrest portion 1b pivotable in relation thereto about a swivel axis A. For controlling the pivot motion, a seat recliner mechanism 2 is arranged between the seating portion 1a and the backrest portion 1b. The seat recliner mechanism 2 comprises a fitting member 2a affixed to the seating portion and a fitting member 2b affixed to the backrest portion which can be rotated in relation to one another. Hereby, the rotation is determined by an adjustment mechanism 3 comprising, for example, an external gear wheel (not shown) with external teeth and an internal gear wheel (not shown) with internal teeth, where the internal gear wheel rotates eccentrically in relation to the external gear wheel upon manual or automatic actuation. Eccentric seat recliner mechanisms 2 of this type are well known among experts in the art and will therefore not be further described.

Using such a seat recliner mechanism 2, swiveling of the backrest portion 1b in relation to the seating portion 1a leads to both a rotational motion about the swivel axis A and a translational motion of the swivel axis A, i.e., to a tumbling motion. In order to obtain a reliable value for an evaluation or further processing of the rotational position of the backrest portion 1b in relation to the seating portion 1a characterizing solely the rotational motion about the swivel axis A, the angle measurement system 5 is utilized which is subsequently described first by means of von FIG. 2A and FIG. 2B.

Thus, a shifting mechanism 6 on the seating portion is provided which is connected to the seating portion 1a, i.e., which is adjusted together with the seating portion 1a provided that the seating portion 1a is adjustable. The shifting mechanism 6 on the seating portion includes a shifting element 6a on the seating portion which is longitudinally displaceable guided by a guide element 6b that is attached to the seating portion in a position fixed manner, for example, by means of some sort of a slide bearings or a rolling bearings or similar. The guide element 6b on the seating portion is attached to the seating portion 1a, for example, on a frame structure of the seating portion 1a.

Further, a shifting mechanism 7 on the backrest portion is provided which is connected to the backrest portion 1b, i.e., adjusted together with the backrest portion 1b, in particular, pivoted together with the backrest portion 1b. The shifting mechanism 7 on the backrest portion includes a shifting element 7a on the backrest portion which is longitudinally displaceable guided by a guide element 7b on the backrest portion in a position fixed manner, for example, also by means of some sort of a slide bearings or a rolling bearings or similar. The guide element 7b affixed to the backrest portion is attached to backrest portion 1b, for example, on a frame structure of the backrest portion 1b.

For the two shifting elements 6a, 7a displaceable mounted in the guide elements 6b, 7b, owing to their respective arrangements on the

seating portion 1a on the backrest portion 1b respectively, there will be different shifting directions R6, R7 in relation to a coordinate system referencing the vehicle seat. Hereby, the respective first or second shifting direction R6, R7 depends on the position of the seating portion 1a, provided that it is adjustable, or, respectively, of the backrest portion 1b. According to FIG. 2A, the shifting mechanisms 6, 7 are attached to the seating portion 1a or on the backrest portion 1b respectively in such a manner that the respective shifting directions R6, R7 are aligned on or at least parallel to longitudinal axes L1a, L1b of the seating portion 1a or of the backrest portion 1b respectively, while, in FIG. 2B, they run at an angle to the longitudinal axes L1a, L1b. Hereby, the longitudinal axes L1a, L1b are the axes of the seating portion 1a or of the backrest portion 1b respectively which correspond to their largest expansion, as shown in FIG. 2A and FIG. 2B.

The respective shifting element 6a, 7a is guided within a limited bearing section B6a, B7a through the respective guide element 6b, 7b, for example, in the way of a slide bearings or a roller bearing with roller or similar. The two shifting elements 6a, 7a are swiveling coupled to one another at a pivot point D via any kind of mounting element 8, for example, via a wave-like component resting in bushes, where the pivot point D lies outside the respective bearing section B6a, B7a. Then, pivoting the backrest portion 1b in relation to the seating portion 1a will automatically cause, via the guide elements 6b, 7b, affixed to the seating portion or the backrest portion respectively, also a pivoting of the two coupled shifting elements 6a, 7a on the seating portion or on the backrest portion respectively against one another about the axis of rotation D, so that an angle α between the shifting elements 6a, 7a corresponding to the tilt adjustment of the backrest portion 1b in relation to the seating portion 1a changes. This is shown, by way of example, in the FIGS. 3A, 3B, 3C for different pivot positions.

Thus, the position of the pivot point D is independent from the position of the swivel axis A of the seating portion 1a and of the backrest portion 1b. Rather, the position of the swivel axis A relative to the position of the pivot point D changes due to the translational motion of the seat recliner mechanism 2. This is because such a translational motion causes a shift of the shifting elements 6a, 7a relative to the respective guide elements 6b, 7b along the shifting directions R6, R7 so that this translational motion is not transferred onto the pivot point D but is virtually filtered out or compensated respectively. Only the rotation component is transferred over also to the shifting elements 6a, 7a by virtue of a corresponding swiveling of the guide elements 6b, 7b. This rotational motion of the two shifting mechanisms 6, 7 against one another or, respectively, the change of the angle α between the shifting elements 6a, 7a can be determined using such an angle measurement system 5, in the manner described below:

Thus, according to the embodiment shown in FIG. 2A and FIG. 2B, a sensor assembly 9 is provided adjacent to the pivot point D which is configured to detect the rotation movement between the shifting element 6a on the seating portion and the shifting element 7a on the backrest portion and, therewith, the angle α or, respectively, the change of the angle α. To that end, the sensor assembly 9 may comprise, for example, an electronic rotation or tilt sensor. This can determine, on the basis of an optical and/or mechanical operation principle, a value for the angle α or, respectively, a value for the change of the angle α between the shifting elements 6a, 7a and put this out in a sensor signal 9S for further processing. This way, it is possible, for example, after a suitable initial calibration or initialization respectively (depending on the position of the shifting elements 7a, 7b on the seating portion 1a or, respectively, on the backrest portion 1b or, respectively, relative to one another), to continuously detect a tilt adjustment of the backrest portion 1b (without translational component) from this signal 9S and to further utilize this information accordingly.

This utilizes the fact that the two shifting elements 7a, 7b upon adjustment of the backrest portion 1b in relation to the seating portion 1a undergo the same change of the angle α as the backrest portion 1b in relation to the seating portion 1a. Thus, in the initialization or calibration respectively, the constant following from the position of the shifting elements 7a, 7b at the seating portion 1a or, respectively, at the backrest portion 1b via which the change of the measured angle α can be unambiguously recalculated into the angle between the backrest portion 1b and the seating portion 1a (angle between the backrest portion 1b and the seating portion 1a=constant+change of the measured angle α between the shifting elements 7a, 7b).

In the alternative embodiment of the sensor assembly 9 shown in the FIGS. 3A, 3B, 3C a control cam 10 is attached to one of the shifting elements 7a, 6a, schematically indicated by a corresponding bar fixed in position, and a switching element 11 is attached to the respectively other of the shifting elements 6a, 7a, likewise schematically indicated by a corresponding bar fixed in position. Thus, when the backrest portion 1b pivots in relation to the seating portion 1a, the control cam 10 and the switching element 11 also rotate in relation to one another.

The switching element 11 has at least two switching positions S; S1, S2, . . . . The control cam 10 is configured such that it can bring the switching element 11 into different switching positions S depending on the value of the angle α, with each switching position S being associated with a certain angle α or a certain angular range dα of the angle α. Since the control cam 10 and the switching element 11 are attached to the respective shifting element 6a, 7a, here, too, the translational motion is already filtered out.

For allocating the switching position S to an angle α or an angular range da the control cam 10 comprises an outer control surface 10a which collaborates with the switching element 11 in the following manner:

In a switching element 11 with two switching positions S, for example, a non-actuated first switching position S1 and an actuated second switching position S2, as shown in FIG. 3A, the control cam 10 in a first angular range da 1 of the angle α does not affect the switching element 11 or acts on it such that the switching element 11 is brought into the first switching position S1 (non-actuated). In a second angular range dα2 of the angle α the control cam 10 acts on the switching element 11 such that the switching element 11 is brought into the second switching position S2 (actuated. In a third angular range dα3 of the angle α the control cam 10 acts on the switching element 11 such that the switching element 11 is brought again into the first switching position S1 (non-actuated). To that end, the radially outer control surface 10a is provided, for example, with two edge-side steps 10b or edges that serve for the switching in the respective angle regions. Alternatively, or in addition, the control surface 10a may also extend in the axial direction (in relation to the pivot point D), depending on the arrangement of the switching element 11.

Hereby, in the embodiment shown, the first angular range dα1 of the angle α is associated with an upright seating position of the backrest portion 1b, while the second angular range dα2 of the angle α is associated with intermediate positions of the backrest portion 1b that exist upon folding into an easy entry position. In the third angular range dα3 of the angle α the easy entry position has been reached. Thus, based on the switching position S of the switching element 11, it is possible, for the respective design of the control cam 10 to detect in a simple manner in which position the backrest portion 1b is currently situated. In the output sensor signal 9S the switching position S can be processed or put out in coded form so that from this, for the respective design of the control cam 10 a tilt adjustment of the backrest portion 1b (without translation component) can be determined and this Information can be further utilized accordingly.

In a switching element 11 with more than two switching positions S, for example, also with continuous adjustability, even further angle regions α or even individual angles a or changes of the angle α can be determined directly and put out in the sensor signal 9S. To that end the outer control surface 10a is configured to be suitably multi-step (s. FIG. 4A) or provided with a corresponding continuously rising edge (FIG. 4B) so as to attain a corresponding (multi-step or continuously changing) mutual reaction with the accordingly configured (multi-step or continuously operatable) switching element 11.

In all of the described types of sensing of the angle α the translation component of the tumble movement of the seat recliner mechanism 2 is filtered out, and, thereby, only the rotational motion of the fitting members 2a, 2b or, respectively, of the backrest portion 1b in relation to the seating portion 1a is detected. This can be used to detect a tilt adjustment of the backrest portion 1b (without translation component) in an exact manner from the sensor signal 9S, and this information can be further used accordingly.

The following numbered clauses include embodiments that are contemplated and non-limiting:
Clause 1. A vehicle seat having a seating portion and a backrest portion, the seating portion being connected with the backrest portion via a seat recliner mechanism so that the backrest portion can pivot in relation to the seating portion about a swivel axis, the vehicle seat further comprising an angle measurement system including a sensor assembly, the sensor assembly being adapted to generating and putting out a sensor signal characterizing the tilt adjustment of the backrest portion in relation to the seating portion.

Clause 2. The vehicle seat of clause 1, any other suitable clause, or any combination of suitable clauses, wherein the angle measurement system is provided with a shifting mechanism on the seating portion which is attached to the seating portion, and a shifting mechanism on the backrest portion which is attached to the backrest portion, where the shifting mechanism on the seating portion is provided with a shifting element on the seating portion which is supported on the seating portion movable along a first shifting direction, and the shifting mechanism on the backrest portion is provided with a shifting element on the backrest portion which is supported on the backrest portion movable along a second shifting direction.

Clause 3. The vehicle seat of clause 2, any other suitable clause, or any combination of suitable clauses, wherein the shifting element on the seating portion and the shifting element on the backrest portion are swiveling coupled together in a pivot point so that in the event of a tilt adjustment of the backrest portion in relation to the seating portion an angle between the two shifting elements changes, and the sensor assembly is configured to generate and put out the sensor signal depending on the angle between the two shifting elements.

Clause 4. The vehicle seat of clause 1, any other suitable clause, or any combination of suitable clauses, wherein the shifting mechanism on the seating portion is provided with a guide element affixed to the seating portion, in which the shifting element on the seating portion is mounted in a longitudinally displaceable manner.

Clause 5. The vehicle seat of clause 4, any other suitable clause, or any combination of suitable clauses, wherein the shifting mechanism on the backrest portion is provided with a guide element affixed to the backrest portion, in which the shifting element on the backrest portion is mounted in a longitudinally displaceable manner.

Clause 6. The vehicle seat of clause 1, any other suitable clause, or any combination of suitable clauses, wherein the first shifting direction of the shifting element on the seating portion is in or at least parallel to a longitudinal axis of the seating portion.

Clause 7. The vehicle seat of clause 1, any other suitable clause, or any combination of suitable clauses, wherein the second shifting direction of the shifting element on the backrest portion is on or least parallel to a longitudinal axis of the backrest portion.

Clause 8. The vehicle seat of clause 1, any other suitable clause, or any combination of suitable clauses, wherein the first shifting direction of the shifting element on the seating portion is at an angle to a longitudinal axis of the seating portion.

Clause 9. The vehicle seat of clause 1, any other suitable clause, or any combination of suitable clauses, wherein, the second shifting direction of the shifting element on the backrest portion is at an angle to a longitudinal axis of the backrest portion.

Clause 10. The vehicle seat of clause 1, any other suitable clause, or any combination of suitable clauses, wherein the shifting element on the seating portion and/or the shifting element on the backrest portion are mounted by means of a slide bearings or a rolling bearings movable in the respective shifting direction.

Clause 11. The vehicle seat of clause 1, any other suitable clause, or any combination of suitable clauses, wherein the sensor assembly is provided with an electronic rotation sensor and/or tilt sensor that is adapted to determine, on the basis of an optical and/or a mechanical and/or a magnetic operating principle, a value for the angle and/or a change of the angle between the shifting elements and to put out the sensor signal depending thereon.

Clause 12. The vehicle seat of clause 1, any other suitable clause, or any combination of suitable clauses, wherein the sensor assembly is provided with a control cam which is attached to one of the shifting elements, and a switching element having at least two switching positions which is attached to the respective other shifting element, so that the control cam adjusts in relation to the switching element when the backrest portion pivots in relation to the seating portion, whereby the control cam acts on the switching element at least in individual angle regions of the angle between the two shifting elements so as to adjust or change a switching position of the switching element, and

the sensor assembly is adapted to generate the sensor signal depending on the switching position of the switching element.

Clause 13. The vehicle seat of clause 12, any other suitable clause, or any combination of suitable clauses, wherein the control cam is provided with a control surface, where the control surface acts on the switching element depending on the angle between the two shifting elements so as to set the switching element to the respective switching position or to maintain the switching position or to change the switching position.

Clause 14. The vehicle seat of clause 13, any other suitable clause, or any combination of suitable clauses, wherein the control surface of the control cam is facing radially outwards and/or in an axial direction.

Clause 15. The vehicle seat of clause 12, any other suitable clause, or any combination of suitable clauses, wherein allocated to each switching position of the switching element is at least one angle or at least one angular range between the two shifting elements, and allocated to each angle or each angular range between the two shifting elements is at least one tilt adjustment of the backrest portion in relation to the seating portion.

Clause 16. The vehicle seat of clause 12, any other suitable clause, or any combination of suitable clauses, wherein the switching element has two switching position, and the control cam is configured such that it
in a first angular range of the angle, does not act on the switching element or acts on the switching element in such a way that the switching element is set to a first switching position, and
in a second angular range of the angle, acts on the switching element in such a way that the switching element is set to a second switching position, and
in a third angular range of the angle, does not act on the switching element or acts on the switching element in such a way that the switching element is set to the first switching position.

Clause 17. The vehicle seat of clause 16, any other suitable clause, or any combination of suitable clauses, wherein the backrest portion
in the first angular range of the angle is in an upright seating position,
in the second angular range of the angle is between the upright seating position and an easy entry position, and
in the third angular range of the angle is in the easy entry position.

Clause 18. The vehicle seat of clause 1, any other suitable clause, or any combination of suitable clauses, wherein the seat recliner mechanism is configured, for example, including a fitting element attached to the seating portion, a fitting element attached to the backrest portion, and an adjustment mechanism controlling the rotation of the fitting members in relation to one another, in such a way that the backrest portion and the seating portion swivel in relation to one another in a tumbling movement.

### LIST OF REFERENCE NUMERALS

1 vehicle seat
1a seating portion
1b backrest portion
2 seat recliner mechanism
2a fitting member affixed to the seating portion
2b fitting member affixed to the backrest portion
3 adjustment mechanism
5 angle measurement system
6 shifting mechanism on the seating portion
6a shifting element on the seating portion
6b guide element affixed to the seating portion
7 shifting mechanism affixed to the backrest portion
7a shifting element on the backrest portion
7b guide element affixed to the backrest portion
8 mounting element
9 sensor assembly
9S sensor signal
10 control cam
10a control surface
10b step
11 switching element
α angle between the shifting elements 6a, 7a
A swivel axis
B6a bearing section of the shifting element 6a on the seating portion
B7a bearing section of the shifting element 7a on the backrest portion
D pivot point
dα angular range of the angle α
dα1 first angular range of the angle α
dα2 second angular range of the angle α
dα3 third angular range of the angle α
L1a longitudinal axis of the seating portion 1a
L1b longitudinal axis of the backrest portion 1b
R6 first shifting direction of the shifting element 6a on the seating portion in relation to the guide element 6b affixed to the seating portion
R7 second shifting direction of the shifting element 7a on the backrest portion in relation to the guide element 7b affixed to the backrest portion
S switching position of the switching element 11
S1 first switching position
S2 second switching position

1. A vehicle seat having a seating portion and a backrest portion, the seating portion being connected with the backrest portion via a seat recliner mechanism so that the backrest portion can pivot in relation to the seating portion about a swivel axis,
the vehicle seat further comprising an angle measurement system including a sensor assembly, the sensor assembly being adapted to generating and putting out a sensor signal characterizing the tilt adjustment of the backrest portion in relation to the seating portion,
wherein the angle measurement system is provided with a shifting mechanism on the seating portion which is attached to the seating portion, and a shifting mechanism on the backrest portion which is attached to the backrest portion,
where the shifting mechanism on the seating portion is provided with a shifting element on the seating portion which is supported on the seating portion movable along a first shifting direction, and the shifting mechanism on the backrest portion is provided with a shifting element on the backrest portion which is supported on the backrest portion movable along a second shifting direction,
where the shifting element on the seating portion and the shifting element on the backrest portion are swiveling coupled together in a pivot point so that in the event of a tilt adjustment of the backrest portion in relation to the seating portion an angle between the two shifting elements changes, and the sensor assembly is configured to generate and put out the sensor signal depending on the angle between the two shifting elements.

2. The vehicle seat according to claim 1, wherein the shifting mechanism on the seating portion is provided with a guide element affixed to the seating portion, in which the shifting element on the seating portion is mounted in a longitudinally displaceable manner, and
the shifting mechanism on the backrest portion is provided with a guide element affixed to the backrest portion, in which the shifting element on the backrest portion is mounted in a longitudinally displaceable manner.

3. The vehicle seat according to claim 1, wherein the first shifting direction of the shifting element on the seating portion is in or at least parallel to a longitudinal axis of the seating portion, and/or the second shifting direction of the shifting element on the backrest portion is on or least parallel to a longitudinal axis of the backrest portion.

4. The vehicle seat according to claim 1, wherein the first shifting direction of the shifting element on the seating portion is at an angle to a longitudinal axis of the seating portion, and/or the second shifting direction of the shifting element on the backrest portion is at an angle to a longitudinal axis of the backrest portion.

5. The vehicle seat according to claim 1, wherein the shifting element on the seating portion and/or the shifting element on the backrest portion are mounted by means of a slide bearings or a rolling bearings movable in the respective shifting direction.

6. The vehicle seat according to claim 1, wherein the sensor assembly is provided with an electronic rotation sensor and/or tilt sensor that is adapted to determine, on the basis of an optical and/or a mechanical and/or a magnetic operating principle, a value for the angle and/or a change of the angle between the shifting elements and to put out the sensor signal depending thereon.

7. The vehicle seat according to claim 1, wherein the sensor assembly is provided with a control cam which is attached to one of the shifting elements, and a switching element having at least two switching positions which is attached to the respective other shifting element, so that the control cam adjusts in relation to the switching element when the backrest portion pivots in relation to the seating portion,
whereby the control cam acts on the switching element at least in individual angle regions of the angle between the two shifting elements so as to adjust or change a switching position of the switching element, and
the sensor assembly is adapted to generate the sensor signal depending on the switching position of the switching element.

8. The vehicle seat according to claim 7, wherein the control cam is provided with a control surface, wherein the control surface acts on the switching element depending on the angle between the two shifting elements so as to set the switching element to the respective switching position or to maintain the switching position or to change the switching position.

9. The vehicle seat according to claim 8, wherein the control surface of the control cam is facing radially outwards and/or in an axial direction.

10. The vehicle seat according to claim 7, wherein allocated to each switching position of the switching element is at least one angle or at least one angular range between the two shifting elements, and allocated to each angle or each angular range between the two shifting elements is at least one tilt adjustment of the backrest portion in relation to the seating portion.

11. The vehicle seat according to claim 7, wherein the switching element has two switching position, and the control cam is configured such that it
in a first angular range of the angle, does not act on the switching element or acts on the switching element in such a way that the switching element is set to a first switching position, and
in a second angular range of the angle, acts on the switching element in such a way that the switching element is set to a second switching position, and
in a third angular range of the angle, does not act on the switching element or acts on the switching element in such a way that the switching element is set to the first switching position.

12. The vehicle seat according to claim 11, wherein the backrest portion
in the first angular range of the angle is in an upright seating position,
in the second angular range of the angle is between the upright seating position and an easy entry position, and the third angular range of the angle is in the easy entry position.

13. The vehicle seat according to claim 1, wherein the seat recliner mechanism is configured, in such a way that the backrest portion and the seating portion swivel in relation to one another in a tumbling movement.

14. The vehicle seat according to claim 13, wherein the seat recliner mechanism comprises a fitting element attached to the seating portion, a fitting element attached to the backrest portion, and an adjustment mechanism controlling the rotation of the fitting members in relation to one another in said tumbling movement.
